(19) United States
(12) Patent Application Publication
(10) Pub. No.: US 2015/0270931 A1
(43) Pub. Date: Sep. 24, 2015

(54) METHOD FOR DECODING CONTROL CHANNELS WITH MULTIPLE SUBFRAMES

(71) Applicants: Feifei Sun, Beijing (CN); Xiangyang Zhuang, Lake Zurich, IL (US)

(72) Inventors: Feifei Sun, Beijing (CN); Xiangyang Zhuang, Lake Zurich, IL (US)

(21) Appl. No.: 14/439,485

(22) PCT Filed: Nov. 4, 2013
(86) PCT No.: PCT/CN2013/086499

§ 371 Date: Apr. 29, 2015

(30) Foreign Application Priority Data
Nov. 2, 2012 (CN) 201210433369.2

(51) Int. Cl. H04L 1/18; H04W 72/04; H04L 1/00

(52) U.S. Cl. CPC H04L 1/1845; H04L 1/0072; H04L 1/1816; H04W 72/042; H04W 72/0446

(57) ABSTRACT

A method for a User Equipment (UE) to decode a potential control channel is provided, which includes receiving a transmission of a potential control channel in a first subframe from a base station on a first set of control resources, receiving at least one retransmission of the potential control channel in at least one second subframe subsequent to the first subframe from the base station on a second set of control resources, combining the transmission on the first subframe and the at least one retransmission on the at least one subsequent subframe for attempting to decode the potential control channel.

### CROSS REFERENCE TO RELATED APPLICATIONS

The present application is a National Stage Application of PCT Application Ser. No. PCT/CN2013/086499, filed on Nov. 4, 2013, which claims priority to Chinese application no. CN 201210433369.2, filed on Nov. 2, 2012. The priority applications are hereby incorporated by reference in their entireties.

### FIELD OF INVENTION

This disclosure relates generally to wireless communications and, more particularly, to the decoding of control channel.

### BACKGROUND OF THE INVENTION

Recently, due to the increasingly mature M2M (Machine to Machine) market, the number of cellular M2M subscribers has increased a lot. Smart-metering is one of the typical M2M applications. In the third generation partnership project (3GPP), RANI (Radio Access Network 1) working group is studying a new type of machine type communication (MTC) terminal that makes the cost of terminals for the low-end MTC market competitive with that of GSM/GPRS terminals targeting the same low-end MTC market. In 3GPP TR 36.888, six technologies have been investigated, where single receive RF chain is expected to bring in significant downlink coverage loss. At the same time, smart meters are very often installed in the basements of residential buildings or locations shielded by foil-backed insulations, metalized windows, or traditional thick-walled building constructions. However, such buildings or locations have significantly larger path losses than that in the typical operation condition of normal devices, for which typically mobile networks are not planned. As a result of high path loss and the possibility of single receive chain, some new techniques for improving the coverage are necessary. Moreover, PDCCH (Physical Downlink Control Channel) is one of the weak channels in terms of downlink coverage. Thus, the enhancement of coverage is crucial for the technique of PDCCH/EPDCCH (Physical Downlink Control Channel/Enhanced Physical Downlink Control Channel).

### SUMMARY OF THE INVENTION

Methods for decoding control channels across multiple subframes in mobile communication networks are provided.

In a first embodiment, a decoding method for a User Equipment (UE) to decode a potential control channel is provided, the method comprising: receiving a first transmission of a potential control channel on a first set of control resources in a first subframe from a base station; receiving from the base station at least one retransmission of the potential control channel on at least a second set of control resources in each of the at least one second subframe that is subsequent to the first subframe; and combining the first transmission on the first subframe and the at least one retransmission on the at least one second subframe for attempting to decode the potential control channel.

In another embodiment, a decoding method for a UE to decode a potential control channel is provided, wherein comprising: receiving a potential control channel from a base station on multiple candidate sets of control resources, wherein each of the multiple candidate sets of control resources corresponds to one control channel candidate, and at least one control channel candidate comprises an aggregated set of control resources across multiple subframes; and attempting to decode each control channel candidate to detect the potential control channel

In another embodiment, a decoding apparatus for decoding a potential control channel, operating as a UE is provided, comprising: a wireless module, configured to receive a first transmission of a potential control channel on a first set of control resources in a first subframe from a base station, and receive at least one retransmission of the potential control channel on at least a second set of control resources in each of the at least one second subframe that is subsequent to the first subframe; and a controller module configured to combine the first transmission on the first subframe and the at least one retransmission on the at least one second subframe for attempting to decode the potential control channel.

Other embodiments and advantages are described in the detailed description below. This summary does not purport to define the invention. The invention is defined by the claims.

### BRIEF DESCRIPTION OF THE DRAWINGS

For a more complete understanding of the embodiments, and the advantages thereof, reference is now made to the following descriptions taken in conjunction with the accompanying drawings.

FIG. 1 illustrates a wireless communication system in accordance with some embodiments;

FIG. 2 illustrates an example of transmitting control resources in subframes in accordance with some embodiments;

FIG. 3 illustrates further details of the content of a control channel with multiple subframes in accordance with some embodiments;

FIG. 4A to 4C illustrate combination methods over multiple subframes in accordance with some embodiments;

FIG. 5 illustrates an example of utilizing an acknowledgment signal for (re)transmission in accordance with some embodiments;

FIG. 6 illustrates an example of data channel reception after the decoded control channel in accordance with some embodiments;

FIG. 7 illustrates another example of control resources transmission in accordance with some embodiments;

FIG. 8 illustrates an example of receiving and attempting to decode a control channel candidate at each subframe in accordance with some embodiments;

FIG. 9 illustrates details of the content of control channel and transmission with multiple subframes in accordance with some embodiments;

FIG. 10 illustrates one example of receiving and attempting to decode a control channel candidate in accordance with some embodiments;

FIG. 11 illustrates an example of data resources allocation in accordance with some embodiments;

FIG. 12 illustrates an example of data resources allocation in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections. The making and using of the embodiments of the disclosure are discussed in detail below. It should be appreciated, however, that the embodiments can be embodied in a wide variety of specific contexts. The specific embodiments discussed are merely illustrative, and do not limit the scope of the disclosure. Some variations of the embodiments are described. Throughout the various views and illustrative embodiments, like reference numbers are used to designate like elements.

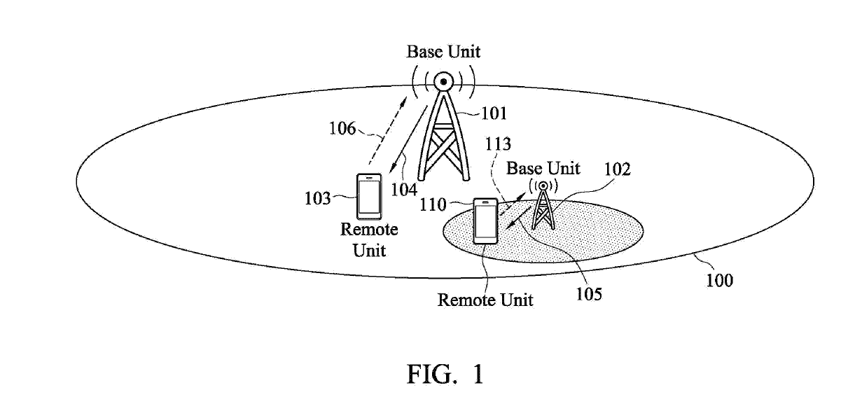

FIG. 1 illustrates a wireless communication system in accordance with some embodiments. The wireless communication system 100 includes one or more fixed base infrastructure units forming a network distribution over a geographical region. The base unit may also be referred to as an access point, access terminal, base station, Node-B, eNode-B, or by other terminology used in the art. As shown in FIG. 1, the base units 101 and 102 serve a number of remote units 103 and 110 within a serving area, for example, a cell, or within a cell sector. In some systems, one or more base units are communicably coupled to a controller to form an access network that is communicably coupled to one or more core networks. The disclosure however is not intended to be limited to any particular wireless communication system.

In some embodiments, the remote unit 103 or 110 comprises a wireless module (not shown in FIG. 1) for performing the functionality of wireless transmissions and receptions to and from the base units 101 and 102, and comprises a controller module (not shown in FIG. 1) for controlling the operation of the wireless module and other functional components, such as a display unit and/or keypad serving as the MMI (man-machine interface), a storage unit storing the program codes of applications or communication protocols, or others. To further clarify, the wireless module may be a radio frequency (RF) unit, and the controller module may be a general-purpose processor or a micro-control unit (MCU) of a baseband unit.

Generally, the serving base units 101 and 102 respectively transmit downlink communication signals 104 and 105 to remote units 103 and 110 in the time and/or frequency domain. Remote units 103 and 110 communicate with one or more base units 101 and 102 via uplink communication signals 106 and 113 respectively. The one or more base units 101 and 102 may comprise one or more transmitters and one or more receivers that serve the remote units 103 and 110. The remote units 103 and 110 may be fixed or mobile user terminals. The remote units may also be referred to as subscriber units, mobile stations, users, terminals, subscriber stations, user equipment (UE), user terminals, or by other terminology used in the art. The remote units 103 and 110 may also comprise one or more transmitters and one or more receivers. The remote units 103 and 110 may have half-duplex (HD) or full-duplex (FD) transceivers. Half-duplex transceivers do not transmit and receive simultaneously whereas full-duplex terminals transmit and receive simultaneously.

In one embodiment, the wireless communication system 100 utilizes an OFDMA or a multi-carrier based architecture including Adaptive Modulation and Coding (AMC) on the downlink and next generation single-carrier (SC) based FDMA architecture for uplink transmissions. SC based FDMA architectures include Interleaved FDMA (IFDMA), Localized FDMA (LFDMA), and DFT-spread OFDM (DFT-SOFDM) with IFDMA or LFDMA. In OFDMA based systems, remotes units 103 and 110 are served by assigning downlink or uplink radio resources that typically comprises a set of sub-carriers over one or more OFDM symbols. Exemplary OFDMA-based protocols include the developing Long Term Evolution (LTE) of the 3GPP UMTS standard and the IEEE 802.16 standard. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading. In other embodiments, the architecture may be based on simpler time and/or frequency division multiplexing/multiple access techniques, or a combination of these various techniques. In alternate embodiments, the wireless communication system 100 may utilize other cellular communication system protocols including, but not limited to, TDMA or direct sequence CDMA.

For example, in the 3GPP LTE system based on OFDMA downlink, the radio resource is partitioned into subframes, and each of the subframes is comprised of 2 slots and each slot has 7 OFDMA symbols in the case of normal Cyclic Prefix (CP). Each OFDMA symbol further comprises a number of OFDMA subcarriers depending on the system bandwidth. The basic unit of the radio resource grid is called Resource Element (RE) which spans an OFDMA subcarrier over one OFDMA symbol.

Each UE gets an assignment, i.e., a set of REs in a Physical Downlink Shared Channel (PDSCH), when a downlink packet is sent from eNB to the UE. The UE gets the downlink and uplink assignment information and other control information from its Physical Downlink Control Channel (PDCCH) or Enhanced Physical Downlink Control Channel (EPDCCH) whose content is dedicated to that UE. In some embodiments, the PDCCH/EPDCCH contains the control information of the resources assigned to a PDSCH in the same subframe of PDCCH/EPDCCH. Specifically, the UE needs to detect whether there is any control channel on each subframe by monitoring a set of PDCCH/EPDCCH candidates in the so-called “blind” PDCCH/EPDCCH decoding process. A PDCCH/EPDCCH candidate occupies an aggregated set of resources known as Control Channel Elements (CCEs) or Enhanced Control Channel Elements (ECCEs). Each aggregated set of CCEs or ECCEs is associated with an aggregation level. When detecting a potential control channel, the UE must try (i.e., decode as if true) all valid (E)PDCCHs candidates before knowing whether there is any PDCCH/EPDCCH and what the content is. The (E)PDCCH candidates monitored by the UE are predefined as search spaces.

A potential control channel (PDCCH or EPDCCH) is contained in a single subframe where the PDSCH also resides. All the control channel candidates are also contained in a single subframe in the current LTE system. For example, at very low SNR conditions encountered in basement deployment of MTC devices, transmission/repetition across multiple subframes will be needed to obtain a suitable SNR level.

In one embodiment of the disclosure, a method for a UE to decode a potential control channel includes: receiving, on a set of control resources in a first subframe, transmission of a potential control channel from a base station; receiving, on another set of control resources in each of the one or more subsequent subframes, retransmission of the potential control channel; combining the first subframe transmission and the retransmissions on the one or more subsequent second subframes for attempting to decode the potential control channel. For the remote unit 103 or 110, the wireless module (RF unit) could receive the first subframe transmission and the retransmissions, and the processor could comprises a combining module for combining the first subframe transmission and the retransmissions, a decoding module for decoding the potential control channel. And the RF unit, the combining module and the decoding module could be integrated into one chip or multiple chips, or may be implemented by hardware, firmware, software, or any combination thereof. The function modules, when executed by processors, for example, allow UE to properly implemented functions.

In the above method, the retransmissions of the potential control channel use the same control channel resources (e.g., CCE or ECCEs). In other words, the first set of control resources in the first transmission and the control resources in each of the retransmission are the same. Alternatively, different control channel resources can be used in retransmissions. In some embodiments, the intervals between retransmissions of the potential control channel are known to the UE to allow the combining process. In other words, the UE has the information of the intervals between retransmissions of the potential control channel. In other embodiments, the same interval between retransmissions may be used, including retransmission on consecutive subframes.

The decoding attempt may be implemented after each retransmission or only at a set of predetermined checkpoints. For the person skilled in the art, the number of the checkpoint(s) could be one or more according to different scenarios, which is known to the UE. Each checkpoint is associated with a certain number of retransmissions, for example, each checkpoint is after a number of retransmissions. The UE knows when to start combining retransmission since the first subframe is chosen from a valid set of predetermined subframess. It should be noted that the valid set of predetermined subframess for a first transmission can be infinite.

Once a UE can successfully detect the control channel (if indeed transmitted) before a known maximal number of retransmission is reached, the UE may send an acknowledgment (ACK) signal to the base station. Due to the high path loss, the UE may need to retransmit the acknowledgment signal on at least one subframe or multiple subframes on the same resources to allow the base station to accumulate the received signal. In order to allow the base station to combine ACK signal transmissions, the property of the ACK signal (e.g., location of the occupied resources) may be known to the base station. More detail will be described later. Note that before the ACK signal can be successfully detected, the base station may retransmit the potential control channel until it can successfully detect the ACK signal or a maximal number of retransmissions is reached.

Data channel transmission may be implemented after the acknowledgement of the control channel, which may be set to a fixed number of subframes after the first transmission of the control channel. In some embodiments, due to the possible long latency of control channel reception and ACK reception, the data channel may be sent together with the control channel. The wireless module of the UE receives transmission of a data channel on a set of possible data channel resources in the first subframe, receives retransmission of the data channel on the set of possible data channel resources in at least one second subframes. The controller module of the UE combines the first subframe transmission and the retransmission on the one or more subsequent subframes, and decodes the data channel from a set of data channel resources indicated in the potential control channel after successful decoding of the potential control channel. Upon successful decoding of the data channel, the UE will also indicate the status (ACK or NACK) of data channel decoding. Such indication may be included in the ACK signal of the control channel or even replace the ACK signal. In the latter case, the ACK signal of the data channel also implies successful decoding of the control channel, and the NACK signal means successful decoding of the control channel but failure decoding the data. Non-transmission on the designated ACK signal resources means a failure of control channel detection.

It should be noted that since the data channel resources used for the data channel are unknown to the UE before control channel decoding, The UE may receive a set of possible data channel resources in the first subframe and subsequent retransmission subframes. The UE may combine the transmission and retransmission on the set of possible data channel resources. But after the control channel is decoded, the UE may process only the data channel resources indicated in the control channel for data channel decoding.

In another embodiment of the disclosure, a method for a UE to decode a potential control channel comprises receiving on at least one or multiple candidate sets of control resources, a potential control channel from a base station, wherein each candidate set of control resources corresponds to a control channel candidate and at least one control channel candidate comprises an aggregated set of control resources across at least one or multiple subframes. The method also comprises attempting to decode each control channel candidate to detect the potential control channel.

In the at least one control channel candidate that comprises an aggregated set of control resources across multiple subframes, the potential control channel is retransmitted over the multiple subframes. For example, the retransmission may be on the same or different control channel resources. In cases where the same control channel resources are used, the UE may combine the control resources across the multiple subframes directly. Based on the combined signal, the UE performs channel estimation, demodulation, and decoding. In other alternative embodiments, each subframe in the aggregated set of control resources may carry different parts of the potential control channel.

A data channel is sent on the resources assigned in the control channel. Due to the high path loss, retransmission on one or more subframes may also be required. The control channel may carry information like the first subframe of data transmission and the number of retransmissions of subframes. In some embodiments, the data channel may be transmitted from the last subframe carrying the control channel. In other embodiments, the data channel may always be sent together with the control channel.

Some further details are the above embodiments are given below.

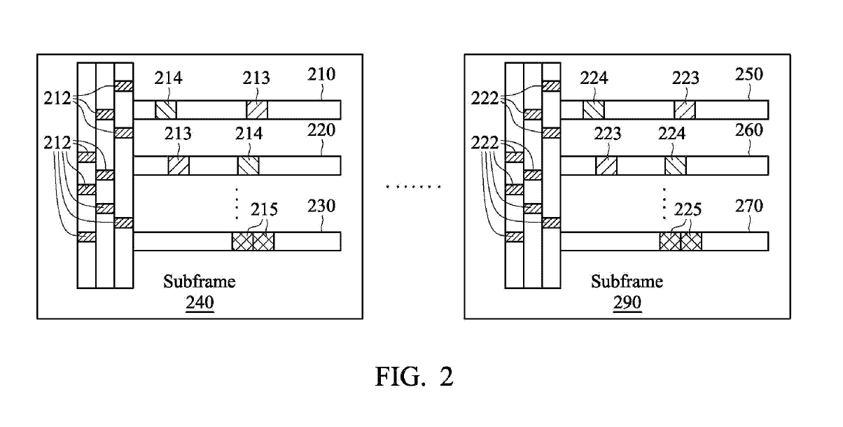

FIG. 2 illustrates an example of transmitting control resources in subframes in accordance with some embodiments. In one embodiment of the disclosure, a method for a UE to decode a potential control channel includes receiving a transmission of a potential control channel in a first subframe from a base station on a first set of control resources, receiving at least one retransmission of the potential control channel in at least one second subframe from the base station on a second set of control resources, combining the transmission on the first subframe and the at least one retransmission on the at least one subsequent subframe for attempting to decode the potential control channel.

Referring now to FIG. 2, the wireless module of the UE receives the transmission of a potential control channel from a base station on a set of control resources (for example, the set of control resources comprises control resources on 210, 220, 230) in a first subframe 240, receives the retransmission of a potential control channel from a base station on another set of control resources (for example, the set of control resources comprises control resources on 250, 260, 270) in each of the one or more subsequent subframes 290. The controller module of the UE combines the first subframe transmission and the retransmissions on the one or more subsequent subframes, and attempts to decode the potential control channel.

A control resource comprises a set of resource elements. One type of control resource in LTE is called control channel element (CCE), as shown in CCE 212 and 222, each of which contains a set of REs in a control region (up to the first three or four OFDM symbols). Another type of control resource in LTE is called enhanced CCE (ECCE), each of which contains REs from one or more pairs of PRBs. In another embodiment, the ECCE 215 and 225 comprises REs from one pair of PRBs 230 and 270 respectively. Therefore, the ECCE 215 and 225 belong to the same pair of ECCE and could be combined directly. ECCE 213, 214, 223, and 224 comprises REs from multiple pairs of PRBs, for example, both ECCE 213 and 214 are from two PRB pairs 210 and 220. The control channel occupies several CCEs/ECCEs in a subframe. For example, as shown in FIG. 2, it can occupy one CCE 212 in the first subframe 240 or two ECCEs 213 and 214 in the first subframe 240. The same control channel is retransmitted in a subsequent subframe 290. In one embodiment, the same set of CCEs/ECCEs is used in the retransmissions. This allows the UE to directly combine the first subframe transmission and the subsequent retransmissions with the same pair of ECCEs. For example, as shown in FIG. 2, ECCE 214 is combined with ECCE 224, ECCE 213 is combined with ECCE 223, ECCE 215 is combined with ECCE 225, and ECCE 212 is combined with ECCE 222.

In some embodiments, after combining, the UE will attempt to decode the potential control channel. The UE will attempt to decode the potential control channel after a set of predetermined checkpoints. For example, the UE may attempt to decode the potential control channel after combining 2, 4, 8 16, 32, 64, or 128 retransmissions. In other embodiments, the UE will attempt to decode the potential control channel after each retransmission. In one example, the number of CCEs/ECCEs in each subframe is fixed, for example, at the maximal aggregation level of 8. Retransmission will continue until a predefined maximal number of retransmissions is reached or when the base station can detect the ACK signal from the UE as described later. For example, when the ECCE 214 is combined with ECCE 224 as shown in FIG. 2, the reference symbols (pilots) embedded in the PRB 210 are also combined with those retransmitted in the PRB 250. This will allow a decent channel estimation which is required in decoding attempts. With the assumption of the same reference symbols in each subframe and the assumption of static or slowly time-varying channels, the UE can combine the reference symbols in the same PRB-pair over subframes to obtain reliable channel estimation.

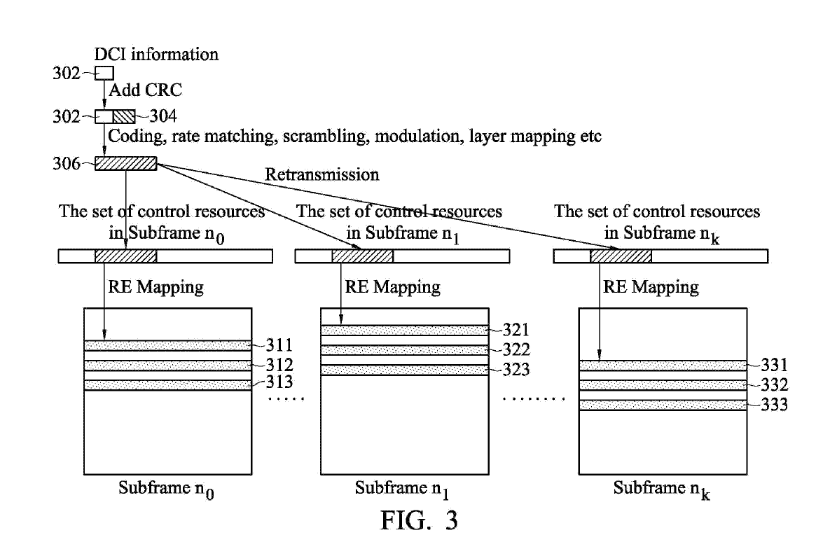

FIG. 3 illustrates further details of the content of control channels with multiple subframes in accordance with some embodiments. Referring now to FIG. 3 where further details of the content of control channel according to LTE are shown. The base station generates downlink control information (DCI) bits 302 for a UE and adds a Cyclic Redundancy Check (CRC) 304, which is scrambled with the corresponding RNTI (Radio Network Temporary Identifier). After channel coding and rate matching, the base station implements scrambling, modulation, layer mapping, and/or RE (resource element) mapping to a set of control resources 306, for example, one or several CCEs/ECCEs, based on pre-defined rules. This set of control resources is transmitted on subframe n₀, where n₀ is known to the UE. In some embodiments, the same information bits are transmitted in one or more subsequent subframes n₁ to nₖ (where k is the maximum number of retransmission), wherein the intervals between retransmissions are known to the UE. In one example, the intervals between subframe n₀ and subsequent subframes n₁ to nₖ are the same, and for the case of interval equal to zero means that the subframes of transmission and retransmission are consecutive and continuous. In another example, the intervals between each subframe n₀ to nₖ are the same and are known to the UE. In another example, the intervals between subframe n₀ and subsequent subframes n₁ to nₖ are different and are known to the UE. In still another example, the intervals between each subframe n₀ to nₖ are different and are known to the UE.

Referring again to FIG. 3, a different set of control channel resources is used in each subframe, i.e., ECCE 311, 312, 313 in subframe n₀; ECCE 321, 322, 323 in subframe n₁; and ECCE 331, 332, 333 in subframe nₖ. Since received control resources cannot be combined directly in this case due to different corresponding channel responses, different combining processes may be implemented by the UE, which will be explained here. For example, the UE accumulates the cell-specific reference symbols (CRS) in a separate processing so that the channel of the entire bandwidth can be estimated reliably first. At the same time, the received control resources are stored over subframes. Once a reasonable channel estimates are obtained, the UE can start processing the retransmissions by correcting the channel effect, after which the channel-corrected signals can be combined for decoding. Compared with retransmission on the same control resources, the above approach needs to buffer more symbols and requires a separate channel estimation process that is based on CRS. The benefit of using different control resources over subframes might be the diversity gain.

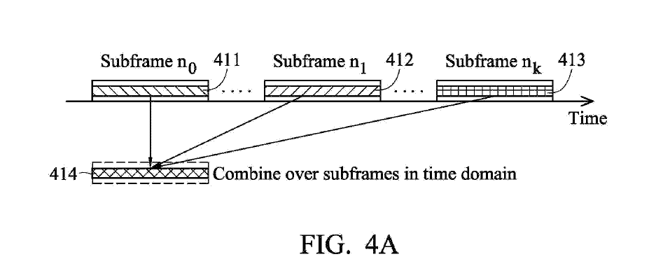

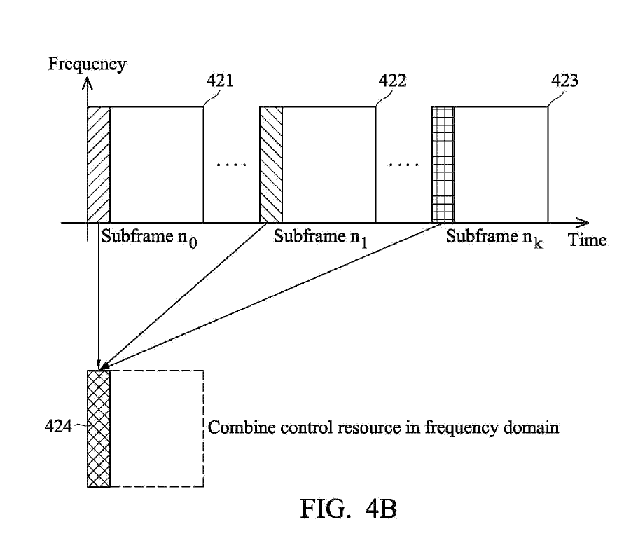

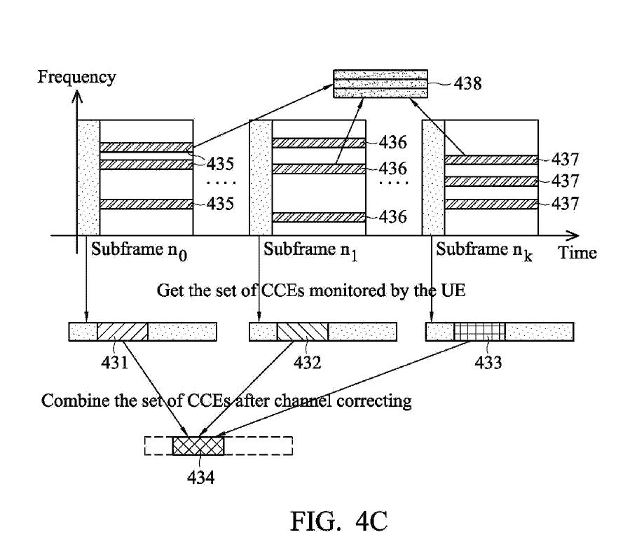

FIG. 4A to 4C illustrate combination methods over multiple subframes in accordance with some embodiments. As shown in FIG. 4A, the received time domain samples in each subframe 411, 412 and 413 are directly combined to obtain the combined signal 414. In other words, the combination is implemented in time domains. Another example of combination illustrated in FIG. 4B is that the UE combines the received frequency samples over subframes 421, 422 and 423 to obtain the combined signal 424. For the above two combining implementations, reference signals are combined together to allow decent channel estimation as described above. Therefore, the combination in this case is implemented in frequency domains. In other embodiments, as shown in FIG. 4C, different sets of control channel resources are used in each subframe. After transforming the signals into frequency domain and correcting the channel effect, the UE can get and combine the sets of control resources from the subframes of the first transmission and subsequent retransmissions. If the control resource type is CCE, after correcting the channel effect, the UE may combine CCEs 431, 432, 433 into an aggregated set of CCEs 434. For the control resource type ECCE, similarly the UE may combine the PRB-pairs from different subframes, i.e., PRB-pairs 435, 436 and 437, to obtain an aggregated ECCE set 438. Therefore, the combination in this case is implemented in both time domains and frequency domains.

Specifically, the UE knows when to start combining retransmissions since the first subframe is chosen from a valid set of predetermined subframess. For example, the first subframe is predefined or predetermined as the first subframe of every set of ten radio frames. In this case, the set is infinite. The set of the predetermined subframess as the first subframe can be configured by the base station.

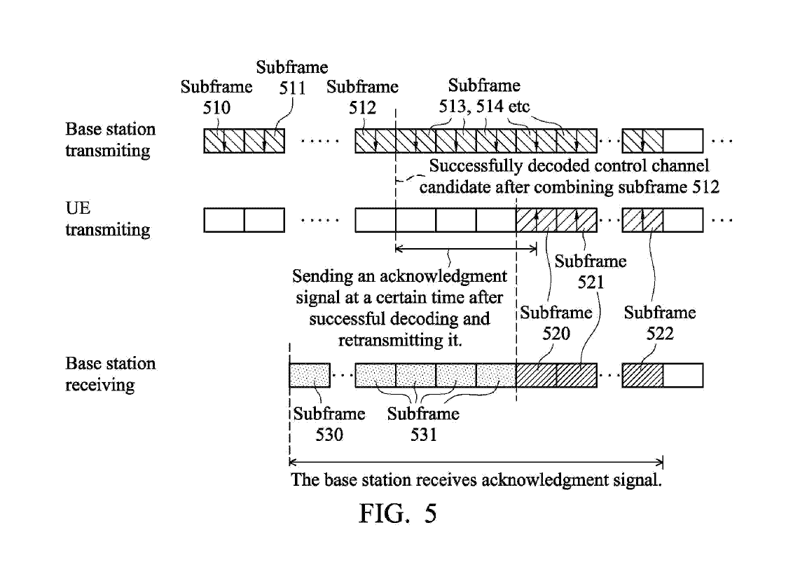

FIG. 5 illustrates an example of utilizing an acknowledgment signal for (re)transmission in accordance with some embodiments. Referring now to FIG. 5, the UE sends an acknowledgment signal to the base station if the UE successfully detects the control channel. The control channel is transmitted first on the subframe 510 and then retransmitted on the subsequent subframes 511, 512. In some embodiments, after combining the first transmission and the subsequent retransmissions before the subframe 512, the UE successfully decodes the control channel candidates. Specifically, after combining the first transmission and the subsequent retransmissions, the UE detects the control channel and starts to send an acknowledgment signal on the subframe 520 with or without any predefined wait time. Due to the high path loss, the UE may need to retransmit the acknowledgment (ACK) signal on multiple subframes 521, 522. In order to allow the base station to combine ACK signal transmissions, the property (e.g., location of the occupied resources) of the ACK signal may be known to the base station. In some embodiments, the same resource in each subframe 520, 521, 522 is used to allow the base station to accumulate the received signal. The maximum transmission time of ACK signal also needs to be known to both UE and the base station. In other embodiments, the UE will transmit the same number of repetitions or retransmissions as the number utilized to successfully detect the control channel. In still other embodiments, the UE retransmits the ACK signal on the at least one or multiple subframe on the same set of control resources.

In some embodiments, since the base station does not know when the UE can successfully detect the control channel and send an ACK signal, the base station will keep monitoring and start receiving the ACK signal on a predefined resource from a certain or predetermined subframes 530 no matter whether there is an ACK signal sent by the UE or not. For example, in LTE the ACK signal shall be sent at the 4th subframe after the subframe sending a physical channel. If the UE has not successfully detected the control channel, no ACK signal will be received on the assigned resource in the subframes 530 and 531 until the UE successfully detects control channel and starts to transmit an ACK signal after a certain time at the subframe 520. Note that before the ACK signal can be successfully detected, the base station may still retransmit the potential control channel in subframes 513, 514 and so on until the ACK is successfully detected or a maximal number of retransmissions is reached.

Specifically, sending an ACK signal to the base station has at least one advantage on the early termination of the retransmission of the control channel to the UE and releasing the resources for the base station. Therefore, the UE may only send an ACK signal if the base station can benefit from early termination of the control channel. If the UE retransmits ACK with the same number of repetitions or retransmission as that of the control channel, it only make sense for the UE to send an ACK signal when the control channel retransmission number k is less than half of the maximum retransmission number K.

In other embodiments, sending an ACK signal to the base station has another advantage of allowing the base station not to send any data unless an ACK signal is received. The base station may save precious resources for a data channel if the UE cannot detect the control channel.

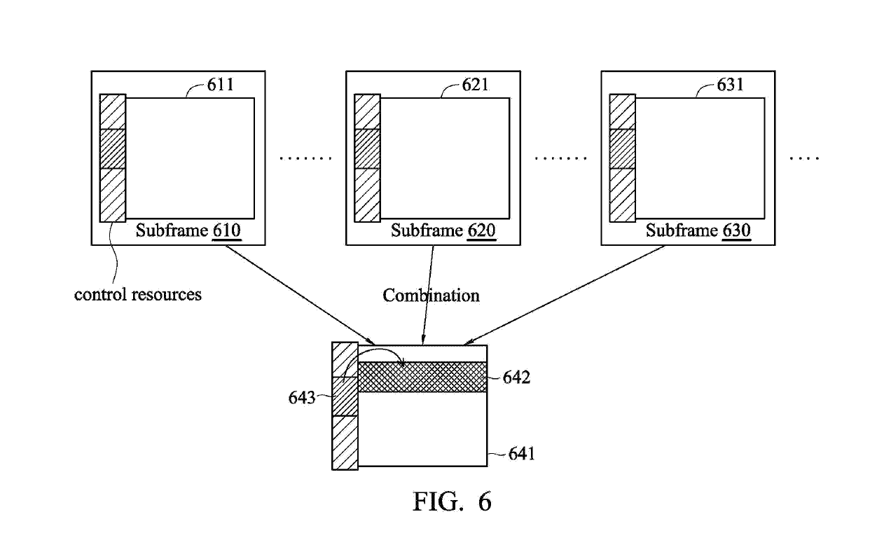

FIG. 6 illustrates an example of data channel reception after the decoded control channel in accordance with some embodiments. As shown in FIG. 6, in some embodiments, the UE receives in the first subframe 610 the transmission of a data channel on a set of possible data channel resources 611, receives in one or more subsequent subframes 620 and 630 the retransmission of the data channel on the set of possible data channel resources 621 and 631; combines the transmission on the first subframe and the retransmission on the one or more subsequent subframes and decodes the data channel from a set of data channel resources 641 indicated in the potential control channel after successful decoding of the potential control channel. In this figure, the data channel is transmitted together with the control channel in the same subframe. Because the resources assigned to the data channel 642 are unknown to the UE before successful decoding of the control channel, the combination of the first data channel transmission and retransmission on the one or more subsequent subframes may include a set of possible data channel resources 611, 621 and 631. Actual assigned resources for the data channel 642 is only a part of the possible data channel resources for which combining is performed. When the UE successfully detects the control channel, the UE may only decode the data channel from the actual set of data channel 642 indicated in the control channel 643.

In some embodiments, after successful decoding of the data channel, the UE will also indicate the status of data channel decoding by an ACK or NACK signal. For example, an ACK signal of the data channel implies successful decoding of the control channel, and a NACK signal means successful decoding of the control channel but failure of data decoding, and non-transmission on the designated ACK signal resources means a failure of control channel detection. It should be noted that non-transmission is declared only after the base station has accumulated all the potential ACK resources. In other embodiments, the ACK signal is only sent by the UE if successfully decoding the data channel. The NACK signal is only sent after achieving the maximum number of retransmissions and the UE successfully detects the control channel but fails to decode the data. When the NACK signal is received by the base station, the base station can transmit another control channel from a starting subframe which indicates another cycle of the same control and data transmission as the last cycle. In this new cycle of data transmission, the base station can assign different resources for the data transmission and/or with a different encoding method, e.g., a different redundant version (RV) in the case of incremental redundancy. After receiving the new cycle of data transmission, the UE can combine the new transmission with the previous one.

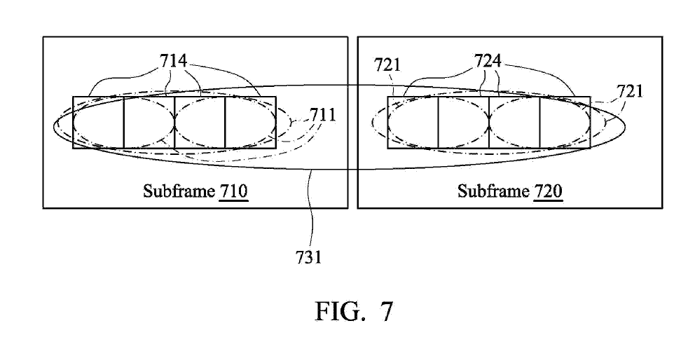

FIG. 7 illustrates another example of control resources transmission in accordance with some embodiments. As shown in FIG. 7, in some embodiments, a method for a UE to decode a potential control channel includes receiving a potential control channel from a base station on multiple candidate sets 711, 721 and 731 of control resources and attempting to decode each control channel candidate to detect the potential control channel. It should be noted that each candidate set of control resources corresponds to a control channel candidate and at least one control channel candidate comprises an aggregated set 731 of control resources across multiple subframes 710 and 720. Candidate sets 711 and 721 of control resources may contain a control channel and both candidates occupy resources only in a single subframe. But in the at least one control channel candidate 731 that comprises an aggregated set of control resources 714 and 724 across multiple subframes 710 and 720, the control channel candidate is transmitted in the resources 714 over subframe 710 and is retransmitted on the same resources 724 over subframe 720. The UE may combine the control resources 714 and 724 across the multiple subframes 710 and 720 directly. Based on the combined signal, the UE processes channel estimation, demodulation, and decoding.

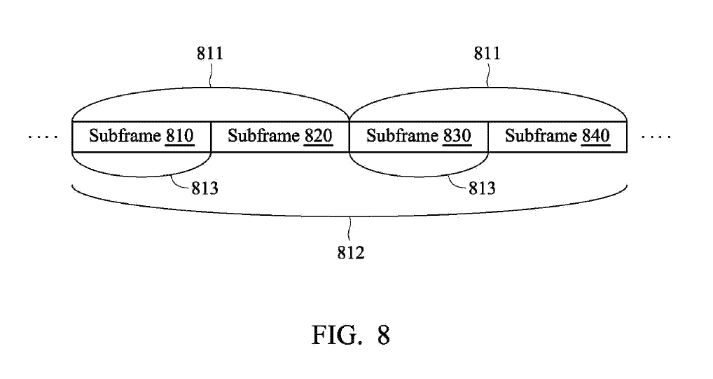

FIG. 8 illustrates an embodiment of the UE for receiving and attempting to decode a potential control channel that comprises an aggregated set of control resources across multiple subframes. In some embodiments, the UE is required to monitor a set of four control channel candidates, corresponding to a set of aggregation levels of CCEs or ECCEs including four, eight, sixteen and thirty-two where the value stands for the number of CCE/ECCE used for the control channel. The UE needs to decode each candidate to detect if there is any control channel. Aggregation levels of sixteen CCE/ECCE 811 and thirty-two CCE/ECCE 812 span over two subframes and four subframes respectively, while aggregation levels of four CCE/ECCE 813 and eight CCE/ECCE 813 are within one subframe. As shown in FIG. 8, the candidate aggregated set of control resources with aggregation level of sixteen comprises CCE/ECCE from subframes 810 and 820, or subframes 830 and 840. The candidate aggregated set with aggregation level thirty-two comprises subframes 810, 820, 830 and 840. The location, for example the index of starting subframe 810 and the subsequent subframes 820, 830 and 840 are both known to the UE. At each subframe, the UE may attempt to decode the control channel candidates at aggregation levels of four and eight. But every other subframe, for example, after receiving both subframe 810 and 820, the UE may attempt to decode at the aggregation level of eight. Similarly, the UE attempts to decode the control channel candidate at the aggregation level of sixteen every four subframes.

The control channel includes the data channel assignment information and the format of data channel retransmission (i.e., starting subframes, retransmission number, etc.). Instead of explicit indication, such information may be implied by the UE. For example, the data channel starts the first transmission at the same subframe of the control channel and the number of retransmissions may also be implied as explained next.

For the case of retransmission on the same control channel resources across different subframes, the UE may successfully decode the control channel before combining all the sets of control resources from all the retransmission subframes. In some embodiments, as shown in FIG. 8, the control channel candidate is transmitted in subframe 810 and is retransmitted in subframes 820, 830 and 840. The UE may successfully decode the control channel after combining subframes 810 and 820 with the control channel candidate at the aggregation level of sixteen. But in the decoded control channel, the number of retransmissions of the control channel is explicitly signaled which may also be defined as the number of retransmissions. With knowledge of the exactly timing, the data channel decoding status indicator can be transmitted on the right or proper subframe known to the base station. For example, the data channel decoding status indicator will be transmitted on the fourth subframe after the last retransmission.

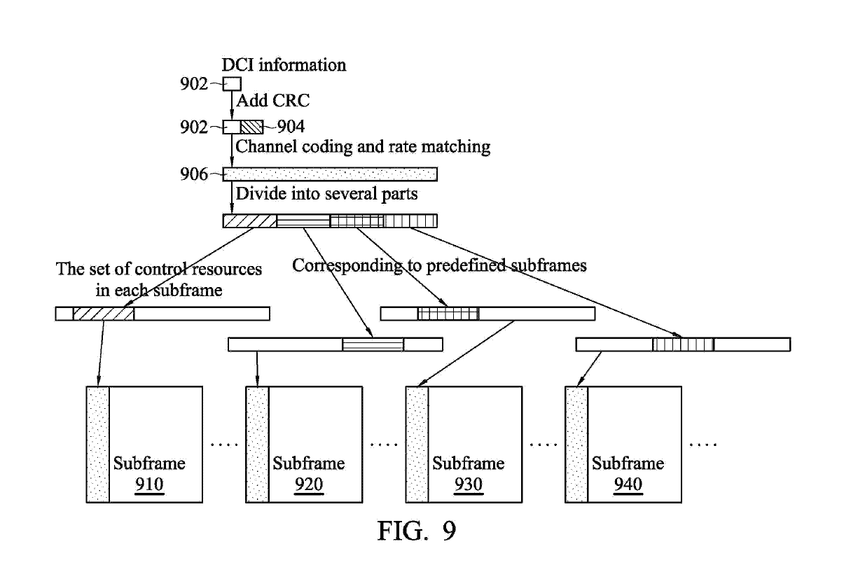

In other embodiments, each subframe in the aggregated set of control resources may carry different parts of the potential control channel. FIG. 9 illustrates details of the content of control channel and transmission with multiple subframes in accordance with some embodiments. The base station generates downlink control information (DCI) bits 902 for several UEs and adds a Cyclic Redundancy Check (CRC) 904 which is scrambled with the corresponding RNTI. After channel coding and rate matching to a certain aggregation level, the base station divides the information bits 906 into several parts corresponding to predetermined subframess 910, 920, 930 and 940.

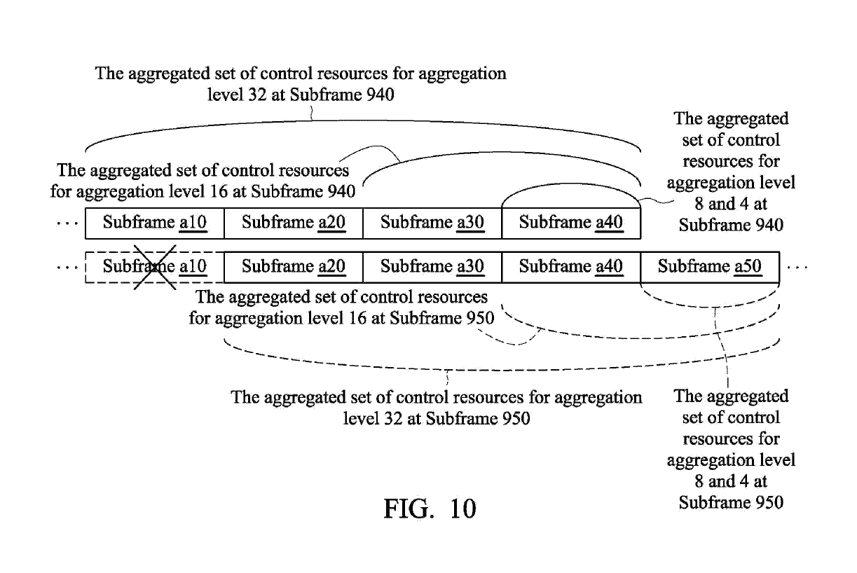

FIG. 10 illustrates one example of receiving and attempting to decode a control channel candidate in accordance with some embodiments. Referring to FIG. 10, the method of the UE to decode control channels for different aggregation levels is that the UE receives and buffers all the aggregated sets of control resources over multiple subframes a10, a20, a30 and a40. Each aggregated set of control resources corresponds to an aggregation level. In some embodiments, the aggregated sets of control resources over one, one, two and four subframe(s) correspond to aggregation levels of four, eight, sixteen and thirty-two respectively. For example, the UE receives the aggregated set of control resources over multiple subframes a10, a20, a30 and a40. At subframe a40, the aggregated sets of control resources for aggregation levels of four, eight, sixteen and thirty-two are set(s) of control resources from subframe a40, subframe a40, subframes a30 to a40, and subframes a10 to a40 respectively. When a new subframe a50 is received, the aggregated sets of control resources for aggregation level of four, eight, sixteen and thirty-two adopts to set(s) of control resources from subframe a50, subframe a50, subframes a40 to a50, and subframes a20 to a50 respectively. The UE attempts to decode a control channel candidate on one or more candidate aggregation levels within the aggregated set of control resources at each subframe.

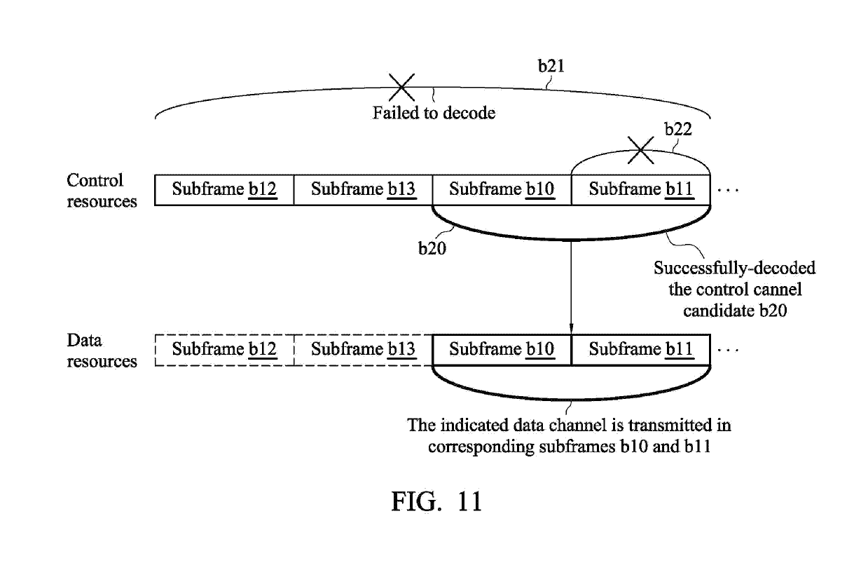

Due to the high path loss, a data channel transmission indicated by the control channel may be implemented at a certain subframe and retransmission on one or more subframes. FIG. 11 illustrates an example of data resources allocation in accordance with some embodiments. Referring to FIG. 11, in one example of data channel reception after control channel decoded, the UE starts to receive in a first subframe b10 transmission of a data channel on a set of data resources indicated in the successfully decoded potential control channel and keeps receiving in at least one subframe b11 corresponding to retransmission of the data channel, where subframes b10 and b11 are transmitting the control channel successfully decoded by the UE. For example, as shown in FIG. 11, the UE attempts to decode each control channel candidates b20, b21 and b22, where the control channel candidate b20 comprises the sets of control resources in subframes b10 and b11, the control channel candidate b21 comprises the sets of control resources in subframes b12, b13, b10 and b11, and the control channel candidate b22 only comprises the set of control resources in subframe b11. The UE fails to decode the control channel candidate b21 and b22 but successfully decodes the control channel candidate b20. Then the UE may infer that the data channel indicated by the successfully decoded control channel is also transmitted in subframes b10 and b11. The UE combines transmission and retransmission on subframes b10 and b11 and decodes the data channel, where the UE only processes the set of data resources indicated in the successfully-decoded control channel b20. The UE sends an acknowledgment signal to the base station to indicate the status of the data channel decoding.

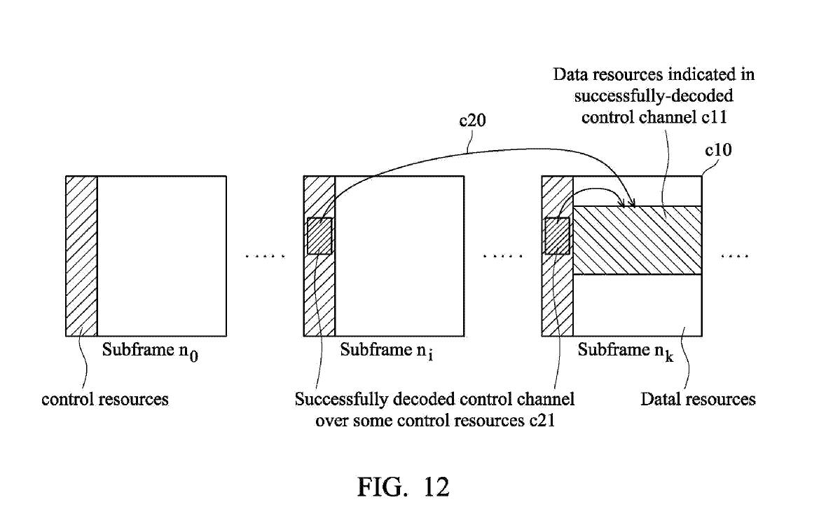

FIG. 12 illustrates another example for data channel reception after control channel decoding. The UE receives in the latest subframe c10 transmission of a data channel on a set of data resources c11 indicated in the control channel candidate c21 and decodes the data channel after the successful decoding of the control channel, wherein the UE can only process the set of data resources indicated in the successfully-decoded control channel. For example in FIG. 12, the UE successfully decodes the control channel in multiple candidate sets of control resources in subframes c10 and c20, and the data resources indicated in the control channel is transmitted on the latest subframe c10. In this case, an acknowledgment signal may be sent to the base station including the status of the data channel decoding after a certain period from receiving the data channel in subframe c10.

In some embodiments, the UE sends an ACK signal to the base station after decoding the potential control channel carried by each of the at least one subframe in the aggregated set of control resources, which means the ACK signal is sent after decoding the whole potential control channel. In other embodiments, the UE sends an ACK signal to the base station after decoding part of the potential control channel carried by any of the at least one subframe in the aggregated set of control resources, which means the ACK signal is sent after decoding part of the whole potential control channel.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

1. A decoding method for a User Equipment (UE) comprising:
receiving a first transmission of a potential control channel on a first set of control resources in a first subframe from a base station;
receiving from the base station at least one retransmission of the potential control channel on at least a second set of control resources in each of at least one second subframe that is subsequent to the first subframe; and
combining the first transmission on the first subframe and the at least one retransmission on the at least one second subframe for attempting to decode the potential control channel.

2. The decoding method as claimed in claim 1, wherein the first set of control resources in the first subframe and the at least a second set of control resources in each of the at least one second subframe are the same.

3. The decoding method as claimed in claim 1, wherein the intervals between the at least one retransmission, and the interval between the first transmission and the at least one retransmission are predefined.

4. The decoding method as claimed in claim 1, wherein the first transmission and at least one retransmission are in consecutive subframes.

5. The decoding method as claimed in claim 3, wherein the intervals between each of the at least one retransmission and the interval between the first transmission and the first of the at least one retransmission are the same.

6. The decoding method as claimed in claim 1, wherein the UE attempts to decode the potential control channel after each checkpoint of a set of predetermined checkpoints, wherein each checkpoint is after a number of retransmissions.

7. The decoding method as claimed in claim 6 wherein the size of the set of checkpoints is one.

8. The decoding method as claimed in claim 1, wherein the UE decodes the potential control channel after each of the at least one retransmission.

9. The decoding method as claimed in claim 1, wherein the first subframe is chosen from a valid set of predetermined subframes.

10. The decoding method as claimed in claim 1, further comprising sending an acknowledgment signal to the base station after the potential control channel is successful decoded.

11. The decoding method as claimed in claim 10, wherein sending an acknowledgment signal to the base station further comprising retransmitting the acknowledgement signal in multiple subframes on a same resource.

12. The decoding method as claimed in claim 1, further comprising:
receiving a transmission of a data channel on a set of possible data channel resources in the first subframe;
receiving at least one retransmission of the data channel on at least a second set of possible data channel resources in each of the at least one second subframe subsequent to the first subframe;
combining the transmission on the set of possible data channels resources in the first subframe with the at least one retransmission on the at least one second subframe; and
decoding the data channel from a set of actually-allocated data channel resources indicated in the potential control channel after successful decoding the potential control channel.

13. The decoding method as claimed in claim 12, further comprising indicating to the base station the status of data channel decoding.

14. The decoding method as claimed in claim 1, further comprising the successfully-decoded potential control channel indicates a resource allocated for a data channel.

15. A decoding method for a UE comprising:
receiving a potential control channel from a base station on multiple candidate sets of control resources, wherein each of the multiple candidate sets of control resources corresponds to one control channel candidate, and at least one control channel candidate comprises an aggregated set of control resources across multiple subframes; and
attempting to decode each control channel candidate to detect the potential control channel.

16. The decoding method as claimed in claim 15, wherein the potential control channel is retransmitted across the multiple subframes in the at least one candidate set of control resources.

17. The decoding method as claimed in claim 15, wherein the at least one candidate set of control resources comprises the same control resources across the multiple subframes.

18. The decoding method as claimed in claim 15, wherein attempting to decode each control channel candidate further comprising attempting to decode each control channel candidate after receiving each subframe.

19. The decoding method as claimed in claim 15, wherein at least one control channel candidate comprises an aggregated set of control resources across multiple subframes further comprising the starting subframe and the subsequent subframes of the multiple subframes are predefined.

20. A decoding apparatus comprising:
a wireless module, configured to receive a first transmission of a potential control channel on a first set of control resources in a first subframe from a base station, and receive at least one retransmission of the potential control channel on at least a second set of control resources in each of the at least one second subframe that is subsequent to the first subframe; and
a controller module configured to combine the first transmission on the first subframe and the at least one retransmission on the at least one second subframe for attempting to decode the potential control channel.

21. The decoding apparatus as claimed in claim 20, wherein the first set of control resources in the first subframe and the at least a second set of control resources in each of the at least one second subframe are the same.

22. The decoding apparatus as claimed in claim 20, wherein the controller module decodes the potential control channel after each checkpoint of a set of predetermined checkpoints wherein each checkpoint is after a number of retransmissions.

23. The decoding apparatus as claimed in claim 20, wherein the controller module sends an acknowledgment signal to the base station after the potential control channel is successful decoded.
